(19) United States
(12) Patent Application Publication
(10) Pub. No.: US 2004/0085168 A1
(43) Pub. Date: May 6, 2004

(54) Apparatus for maintaining magnets in opposing relationship, and support apparatus that utilizes same

(76) Inventor: Michael Martin, Seattle, WA (US)

Correspondence Address: Brinks Hofer Gilson & Lione, NBC Tower, Suite 3600, P.O. Box 10395, Chicago, IL, 60610, US

(21) Appl. No.: 10/693,119

(22) Filed: Oct. 24, 2003

Related U.S. Application Data
(63) Continuation-in-part of application No. 10/161,263, filed on Jun. 3, 2002.

(51) Int. Cl. H01H 9/00

(52) U.S. Cl. 335/207

(57) ABSTRACT

A support surface that utilizes repulsive forces of opposing magnetic fields is described. In preferred embodiments, the support apparatus includes first and second frame members having first and second pluralities of magnets disposed thereon. The pluralities of magnets are oriented such that the first plurality of magnets produces a magnetic field having an orientation that opposes the magnetic fields of the magnets of the second plurality. The first and second frame members interact such that they maintain a substantially static lateral position relative to each other despite the repulsive forces of the opposing magnetic fields. A support member, such as a cushion member, is disposed adjacent one of the frame members, and can be connected thereto. A covering can surround the entire assembly. In particularly preferred embodiments, the frame members have dimensions similar to those of conventional mattresses, and the cover confers the appearance of a conventional mattress onto the support apparatus.

### REFERENCE TO PREVIOUS APPLICATION

This application is a continuation-in-part application of, and claims priority to, copending non-provisional application Ser. No. 10/161,263, filed on Jun. 3, 2002.

### FIELD OF THE INVENTION

The present invention relates to apparatuses for maintaining magnets in an opposing relationship, and support surfaces that utilize such apparatuses. The support surfaces can be used for supporting portions or entire bodies of individuals. The support apparatuses of the present invention utilize opposing magnetic fields to provide at least some of the support to the body or a portion thereof. In a specific embodiment, the present invention relates to a support apparatus for supporting a human being while sleeping.

### BACKGROUND OF THE INVENTION

Human beings, like many animals, prefer to lie down while sleeping. Lying down allows the body to relax, and therefore provides better rest to the body. Throughout history, people have experimented with different types of support surfaces in attempts to provide increased comfort and better rest during sleep. As a result, many different forms of sleeping support services are readily available from commercial sources in modem times. Examples of currently available support surfaces includes conventional mattresses that have support frames and a plurality of spring beneath a cushion member, water mattresses that comprise a bladder filled with fluid, and air mattresses that comprise a chamber filled with air.

Despite the availability of these and other various types of support surfaces, drawbacks remain in the field. For example, currently available types of support surfaces can be simply uncomfortable for some people. Furthermore, some of the support surfaces, such as conventional mattresses having numerous metal springs in addition to padding, can be heavy and cumbersome. Also, other types requires significant maintenance, such as waterbeds, or require the user to expend significant time in setting up the surface prior to use, such as inflatable air mattresses.

Thus, a need exists for a comfortable support surface that overcomes these and other problems present in the prior art.

### SUMMARY OF THE INVENTION

The invention provides apparatuses for maintaining magnets in an opposing relationship. In one embodiment, an apparatus according to the invention comprises a first magnet having a first magnetic field in a first orientation and a second magnet having a second magnetic field in a second orientation that opposes the orientation of the first magnetic field. A plurality of springs is attached to each of the magnets.

The invention also provides support apparatuses for supporting at least a portion of an individual. In one embodiment, a support surface according to the invention includes an apparatus for maintaining magnets in an opposing relationship in accordance with the invention. The support surface can include a plurality of such apparatuses.

The present invention provides a support apparatus for supporting at least a portion of an individual. In preferred embodiments, the present invention provides an apparatus for support of a human being during sleep. The apparatuses of the present invention utilize repulsive forces of opposing magnetic fields to support at least a portion of the body weight of an individual.

The support apparatuses of the present invention can offer several advantages over those apparatuses found in prior art. For example, for some individuals, the apparatuses of the present may provide increased comfort during sleep. The comfort can be increased over that as typically associated with conventional spring-based mattresses, but is not associated with the drawbacks of water and air mattresses, such as the maintenance and setup and taken down problems mentioned above.

In one preferred embodiment, the support apparatus according to the present invention comprises first and second frame members connected to each other in such a manner that at least a portion of the second frame member is substantially parallel to at least a portion of the first frame member. A first plurality of magnets is disposed on the first frame member, and a second plurality of magnets is disposed on the second frame member. Each of the first plurality of magnets has a magnetic field in a first orientation, and each of the second plurality of magnets has a second magnetic field in a second orientation that opposes the orientation of the first magnetic field. A body support surface is disposed on the second frame member. The body support surface is supported at least in part due to the opposing, i.e. repulsive, forces of the first and second plurality of magnets.

In another preferred embodiment, a support apparatus according to the present invention comprises a frame having first and second frame member and a plurality of connectors that secure the first frame member to the second frame member. Each of the first and second frame members comprise a plurality of outer members and at least one inner member that spans from a first outer member to a second outer member. The first plurality of magnets is disposed on at least one inner member of the first frame member, and a second plurality of magnets is disposed on at least one inner member of the second frame member. The magnetic fields of the second plurality of magnets have an orientation that is substantially opposite the magnetic fields of the first plurality of magnets. Also, at least one spacing member, such as a foam member, is disposed between the inner members of the first and second frame members. A body support surface is disposed on the second frame member, and a covering surrounds the frame and the body support surface.

### BRIEF DESCRIPTION OF THE DRAWINGS

FIG. 1 is an exploded view of a support apparatus according to a first preferred embodiment of the present invention.

FIG. 2 is a cross-sectional view of the support apparatus according to the first preferred embodiment.

FIG. 3 is a detailed view of area 1 illustrated in FIG. 2.

FIG. 4 is a perspective view of a support apparatus according to a second preferred embodiment of the present invention.

FIG. 5 is an end view of the support apparatus illustrated in FIG. 4 of the present invention.

FIG. 6 is an exploded view of a support apparatus according to a third preferred embodiment of the present invention.

FIG. 7 is a perspective view of the support apparatus illustrated in FIG. 6 of the present invention.

FIG. 8 is an end view of the support apparatus illustrated in FIG. 7 of the present invention.

FIG. 9 is a side view of an apparatus for maintaining magnets in an opposing relationship according to one embodiment of the invention.

FIG. 10 is a top view of the apparatus illustrated in FIG. 9.

FIG. 11 is a side view of an apparatus for maintaining magnets in an opposing relationship according to another embodiment of the invention.

FIG. 12 is a top view of the apparatus illustrated in FIG. 11.

FIG. 13 is a top view of an apparatus for maintaining magnets in an opposing relationship according to another embodiment of the invention.

FIG. 14 is a perspective view of a support apparatus according to an embodiment of the invention.

### DETAILED DESCRIPTION OF THE INVENTION.

While the invention is defined by the claims appended hereto, a more complete understanding of the invention can be obtained by referencing the following detailed description of preferred embodiments and the accompanying drawings. The following description of preferred embodiments of the invention provides examples of the present invention. The embodiments discussed herein are merely exemplary in nature, and are not intended to limit the scope of the invention in any manner. Rather, the description of these preferred embodiments serves to enable a person of ordinary skill in the relevant art to make and use the present invention.

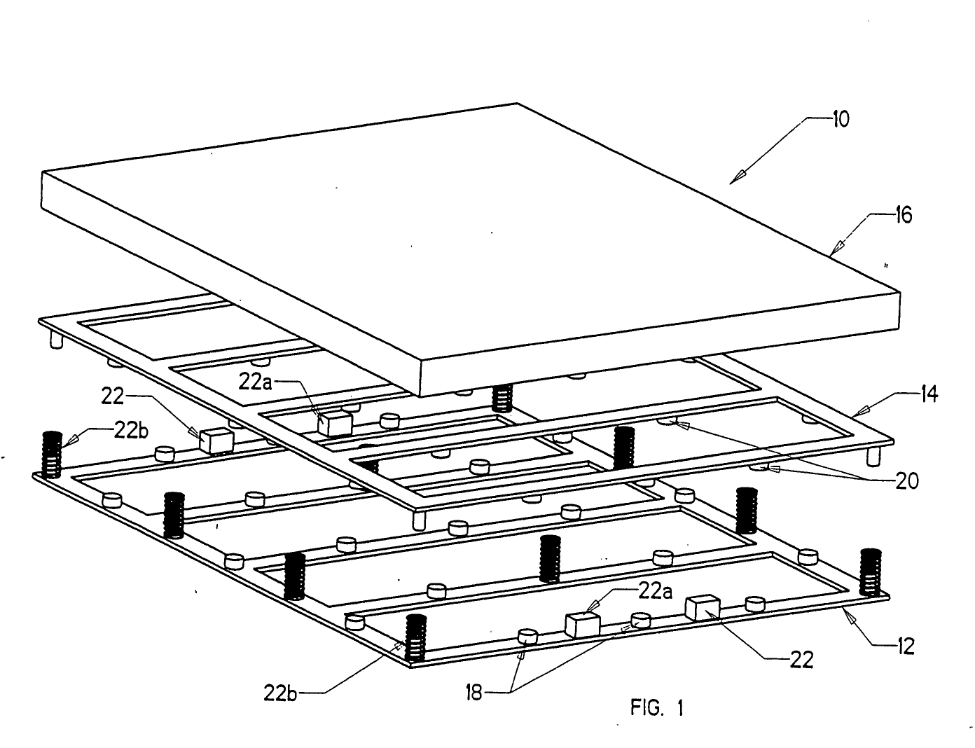

FIGS. 1, 2, and 3 illustrate a support apparatus according to a first preferred embodiment of the present invention. The support apparatus, generally illustrated in the Figures as reference 10, comprises a first frame member 12, a second frame member 14, and a body support surface 16. A first plurality of magnets 18 is disposed on the first frame member, and a second plurality of magnets 20 is disposed on the second frame member 14. One or more spacing members 22 can be disposed on one or both of the frame members 12, 14.

As best illustrated in FIG. 1, the first 12 and second 14 frame members are preferably complementary to each other, having similar configurations. The frame members 12, 14 can be formed from any suitable material, and preferred materials include wood and plastic. Metal frame members can also be used so long as the magnets 18, 20 are adequately secured to the appropriate frame member 12, 14 to prevent migration of the magnets 18, 20 due to attraction to the opposite frame member 12, 14.

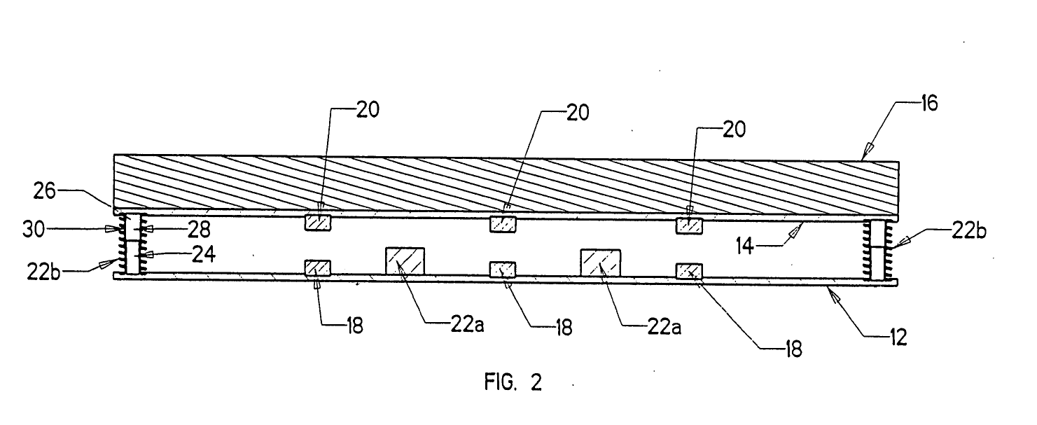

As best illustrated in FIG. 2, the first frame member 12 is arranged relative to the second frame member 14 such that at least a portion of the second frame member 14 is substantially parallel to at least a portion of the first frame member 12. Particularly preferably, the entire second frame member 14 is substantially parallel to the entire first frame member 12. Also, connection between the frame members 12, 14 is necessary to counteract any lateral movement of the frame members 12, 14 that might occur due to the repulsive forces of the opposing pluralities of magnets 18, 20. Accordingly, any suitable connection between the frame members 12, 14 can be utilized.

FIG. 2 illustrates a particularly preferred connection between the frame members 12, 14. In this embodiment, the first frame member 12 defines a projection 24 and the second frame member 14 defines a receptacle 26 adapted to receive the projection 24. The projection 24 can define a mechanical stop, such as pin 28 that is slidably received by slot 30 of the receptacle 26. This arrangement allows vertical movement of the second frame member 14 relative to the first frame member 12, while providing the necessary limit on lateral movement of the frame members 12, 14 due to the repulsive forces of the magnets 18, 20.

Also as best illustrated in FIG. 2, one or more spacing members 22 can be disposed between the frames 12, 14 to provide support in addition to that provided by the repulsive forces of the magnets 18, 20. Any suitable spacing member can be utilized, but the spacing member 22 preferably provides support while allowing vertical movement of the second frame member 14 relative to the first frame member 12. Accordingly, preferred spacing members include foam members, such as blocks of open cell foam that can be compressed, and springs. As best illustrated in FIG. 1, a plurality of foam members 22a are preferably used in conjunction with a plurality of springs 22b. However, it is to be understood that a single type of spacing member can be utilized.

The body support surface 16 provides a surface suitable for supporting at least a portion of a body of an individual, and preferably comprises a surface support suitable for supporting an entire human being. Also, the body support surface 16 provides a comfortable surface for providing such support. Accordingly, the body support surface 16 preferably comprises a cushion member, such as a block of foam or section of fabric. Furthermore, any other suitable mattress-type surface can be used as the body support surface 16. Examples of suitable surfaces include sealed air chambers, fluid filled bladders, and conventional enclosed mattresses.

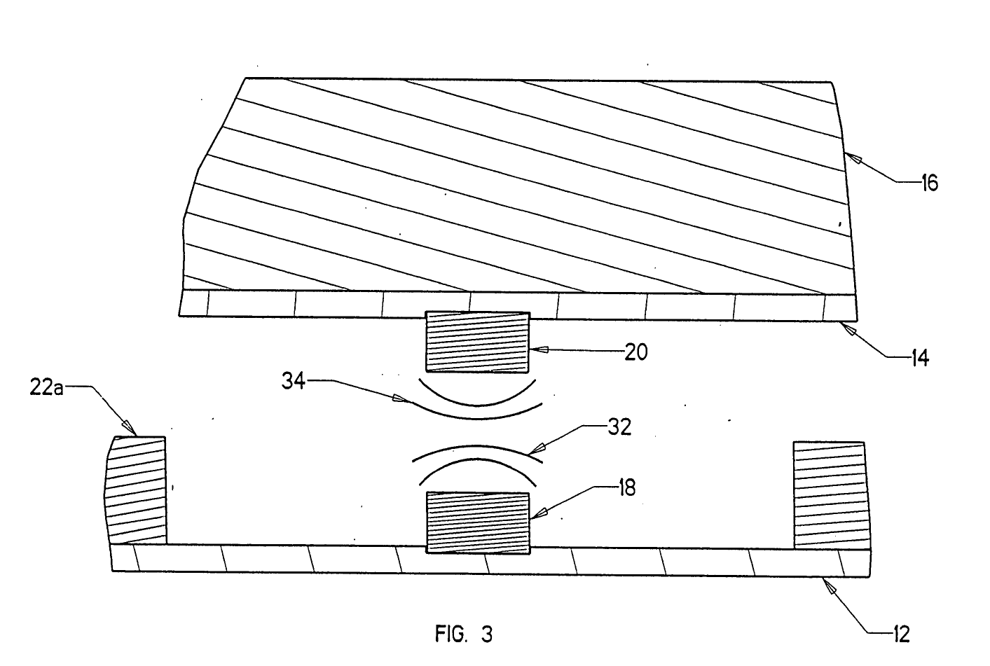

The first 18 and second 20 pluralities of magnets are preferably identical to each other except in the orientation of their respective magnetic fields. To provide the desired support, the first plurality of magnets 18 each has a magnetic field that substantially opposes the individual magnetic fields of each of the second plurality of magnets 20. This is best illustrated in FIG. 3 where the first magnetic field 32 of a magnet of the first plurality 18 substantially opposes a second magnetic field 34 of a magnet of the second plurality 20. This opposition of magnetic fields provides the force that the support apparatus 10 of the present invention utilizes to support at least a portion of a body of an individual.

As illustrated in FIG. 1, the magnets 18, 20 are preferably arranged about the appropriate frame members 12, 14 in a regular pattern. To protect against unintended movement of the magnets due to the repulsive forces of the opposing fields, the magnets 18, 20 are preferably secured to the appropriate frame member 12, 14 by any suitable means, such as adhesive or mechanical connection. Also as illustrated in FIG. 1, the magnets 18, 20 are preferably arranged such that a magnet from the first plurality 18 directly opposes a magnet from the second plurality 20. That is, a magnet from the first plurality 18 is placed directly below a magnet from the second plurality 20, producing maximum repulsion due to opposing magnetic fields. While this arrangement is preferred, it is not necessary. Indeed, based on the type of magnet utilized, the number of magnets utilized, and the expected mass of the body portion to be supported, suitable and optimal arrangements of magnets 18, 20 can be determined and utilized.

Any suitable magnets can be utilized in the present invention, and need only be able to provide a magnetic field that, when opposed to another magnetic fields, provides a sufficient repulsive force to provide the desired support. Preferably, the magnets 18, 20 are selected in size, shape, and number such that the repulsive forces between the first plurality 18 and second plurality 20 are sufficient to provide at least some support to the body portion of interest. The amount of supportive force needed to be provided by the magnets will depend upon several factors, including the size, shape, type and number used, the typical mass of the body portion to be supported, and the presence or absence and number of spacing members 22 in the apparatus 10. The number of magnets can then be determined based on the desired support and strength of magnetic field of the magnet(s) chosen.

In the preferred embodiment, the support apparatus 10 according to the present invention comprises a mattress for supporting the entire body of an individual while at rest. In this embodiment, illustrated in FIG. 1, the pluralities of magnets 18, 20 preferably comprise numerous magnets spaced at regular intervals over the entirety of the appropriate frame member 12, 14. The size of the magnet will depend on the strength of the magnetic field possessed by the magnet. At least one member of the first plurality of magnets 18 comprises a rare earth magnet. These magnets are well known in the art, and are described in various United States patents, including U.S. Pat. No. 6,319,334 to Ohashi, et al. for RARE EARTH/IRON/BORON-BASED PERMANENT MAGNET AND METHOD FOR THE PREPARATION THEREOF; U.S. Pat No. 6,302,939 to Rabin, et al. for a RARE EARTH PERMANENT MAGNET AND METHOD FOR MAKING SAME; and U.S. Pat No. 6,261,515 to Ren, et al. for METHOD FOR PRODUCING RARE EARTH MAGNET HAVING HIGH MAGNETIC PROPERTIES. All of these references are hereby incorporated into this disclosure in their entirety.

Neodymium Iron Born (NdFeB) and Samarium Cobalt (SmCo) magnets represent two distinct types of rare earth magnets. In the present invention, NdFeB magnets are preferred as they are the strongest of the two and, indeed, are the strongest of all permanent magnets.

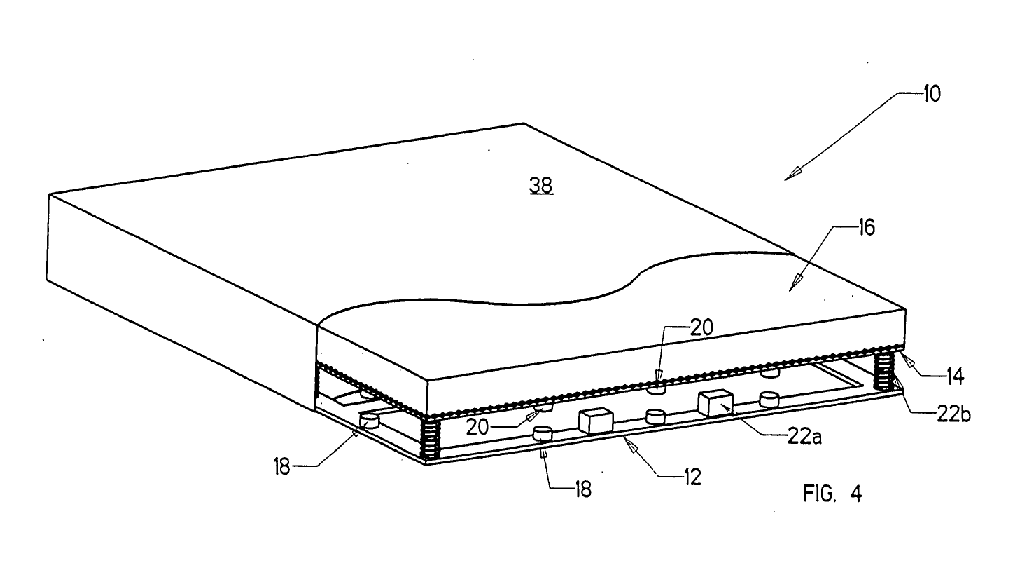

FIG. 4 illustrates the support apparatus 10 according to a second preferred embodiment of the present invention. In this embodiment, the body support surface 16 is secured to the second frame member 14. Any suitable means can be utilized for making this securement between the support surface 16 and the frame member 14. As illustrated in FIG. 4, a stitching 36 between the support surface 16 and the second frame member 14 is preferred. Other suitable securement means include staples and other mechanical securements known in the art.

Also in this embodiment, a covering 38 surrounds the first frame member 12, the second frame member 14, and the body support surface 16. In FIG. 3, the covering 38 is shown partially broken away to illustrate the other components of the support apparatus 10. In final form, however, the covering 38 extends completely around the support apparatus 10. In this embodiment, the covering 38 provides a uniform look to the support apparatus, and also provides a top surface onto which a user can place his or her body for support.

Considering the close proximity in which the covering 38 will be utilized with the body or body portion of a user, the covering is preferably formed from a comfortable material that provides a suitable support surface. Accordingly, the covering 38 is preferably comprised of a fabric, such as cotton, that provides a comfortable feeling to a user. The covering 38 can incorporate additional support materials, such as foam inserts or other materials known in the art.

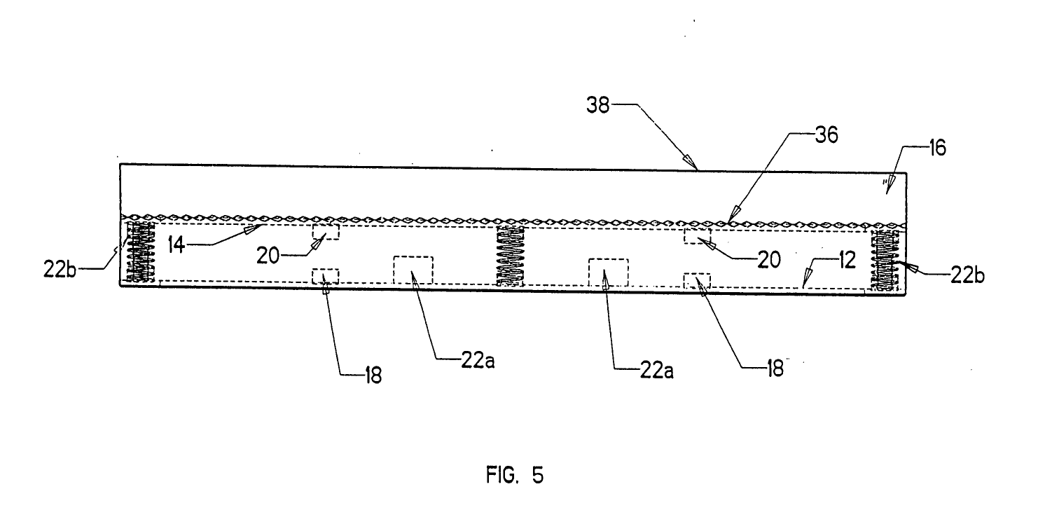

As illustrated in FIG. 5, stitching 36 or other suitable securement means secure the support surface 16 to the second frame member 14, as in the first preferred embodiment.

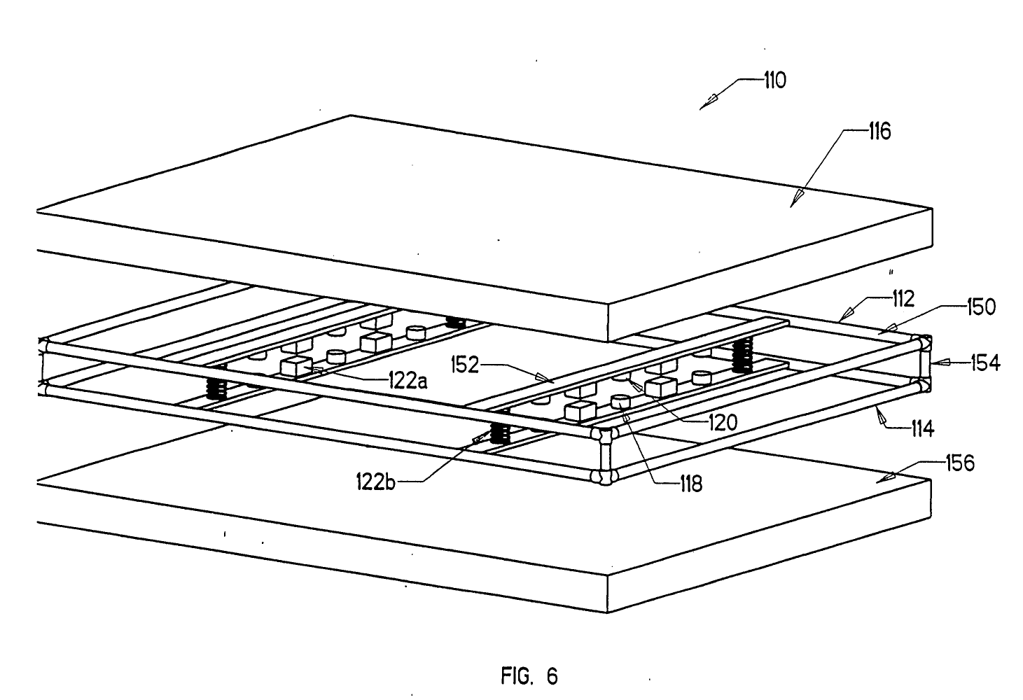

FIGS. 6, 7, and 8 illustrate a third preferred embodiment of a support apparatus according to the present invention. This embodiment is similar to the first preferred embodiment, and thus similar reference numbers in FIGS. 6, 7, and 8 refer to similar features and/or components illustrated in FIGS. 1 through 5. Accordingly, the support apparatus in this embodiment is generally referred to as reference number 110.

The support apparatus 110 according to this embodiment includes a first frame member 112, a second frame 114, a body support surface 116, a first plurality of magnets 118, a second plurality of magnets 120, and can also include one or more spacing members 122.

The first 112 and second 114 frame members preferably comprise a plurality of outer members 150 and at least one inner member 152 spanning from a first outer member 150 to a second outer member 150. The first plurality of magnets 118 is preferably disposed on at least one inner member 152 of the first frame member 112, while the second plurality of magnets 120 is preferably disposed on at least one inner member 152 of the second frame member 114.

Also, a plurality of connectors 154 secure the first frame member 112 to the second frame member 114. In this embodiment, the connectors 154 preferably comprise members that define a plurality of openings for receiving outer members 150 of the appropriate frame member 112, 114.

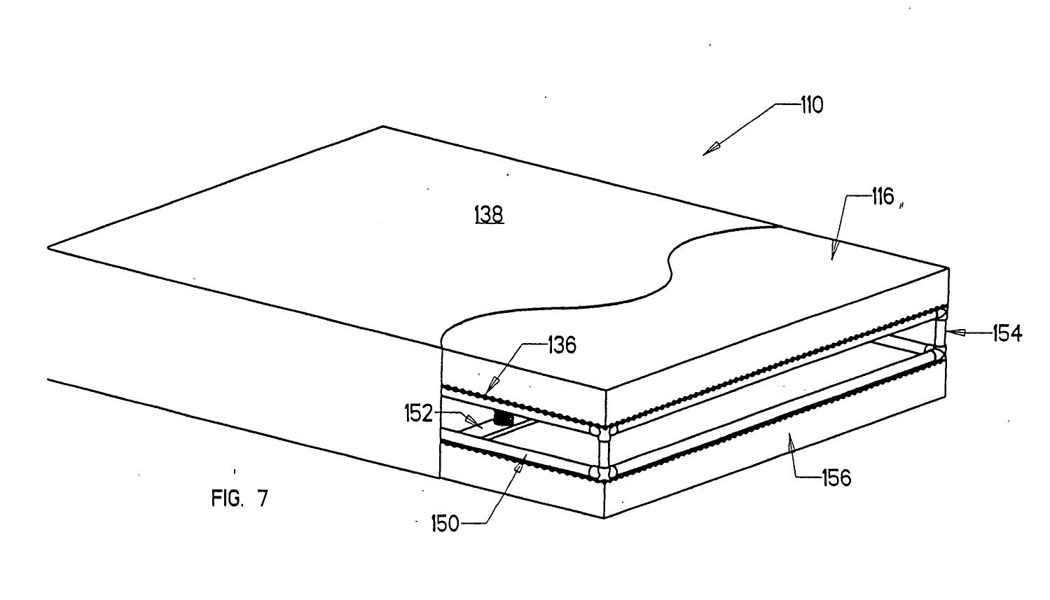

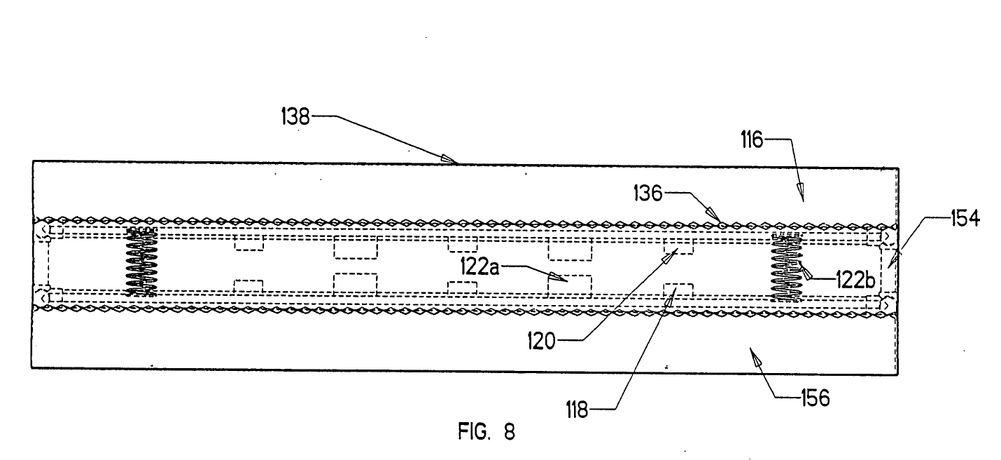

Also in this embodiment, the support apparatus 110 also preferably includes a second body support surface 156. The second body support surface 156 provides a reversible configuration to the support apparatus 110, allowing an individual to utilize either the first 116 or second 156 body support surfaces. Accordingly, the second body support surface 156 is preferably identical to the first body support surface 116. As best illustrated in FIGS. 7 and 8, both body support surfaces 116, 156 are preferably secured to the appropriate frame member 112, 114 in any suitable manner, such as by stitching 136. Also, as best illustrated in FIG. 7, a covering 138 preferably surrounds the entire support apparatus 110, including the first 112 and second 114 frame members, and the first 116 and second 156 body support surfaces. In this embodiment, the support apparatus 110 is completely reversible in both form and appearance.

The invention also provides apparatuses for maintaining magnets in an opposing relationship. FIGS. 9 and 10 illustrate an apparatus 300 according to one embodiment of the invention. In this embodiment, the apparatus 300 comprises first 302 and second 304 magnets. The first magnet 302 has a first magnetic field 306 in a first orientation, and the second magnet 304 has a second magnetic field 308 in a second orientation. The second orientation opposes the first orientation. The apparatus 300 also includes a plurality of springs 310. Each spring 310 of the plurality is attached to the first 302 and second 304 magnets.

Each of the magnets 302, 304 can comprise any suitable magnet. Rare earth magnets, as described above, are particularly well suited for use in the apparatuses of the present invention due to their compact size and relative strength. Further, the first 302 and second 304 magnets can be of identical size, shape, and configuration. Further, the magnets 302, 304 can have magnetic fields 306, 308 of substantially equal strength. In some embodiments, though, one of the magnetic fields 306, 308 can be stronger than the other magnetic field 306, 308. For example, if the apparatus 300 is used in a support apparatus according to the invention, it may be desirable to use a magnet 304 that has a stronger magnetic field 308 than the magnet 302 that is closer in proximity to the surface onto which a body is placed.

The springs 310 can comprise any suitable spring member. Together, the plurality of springs 310 need only allow movement of the magnets 302, 304 towards and away from each other, and prevent substantial lateral movement of the magnets 302, 304 due to the repulsive forces of the opposing magnetic fields 306, 308. The exact size and configuration of the springs 310 will depend on several factors, including the application to which the apparatus 300 is placed. FIGS. 9 and 10 illustrate an example of a suitable spring member 310. In this embodiment, each of the springs 310 comprises first 314 and second 316 arm portions and a coil portion 318 disposed between the arm portions 314, 316.

Each of the plurality of springs 310 is attached to the magnets 302, 304 at attachment points 312. The attachment point 312 can comprise any suitable attachment between the springs 310 and magnets 302, 304. Examples of suitable attachments include weld joints, adhesives, and mechanical interconnections of the elements. Further, another member, such as a clamp, can be used to retain the springs 310 adjacent one or both of the magnets 302, 304. A perimeter claim that surrounds one of the magnets 302, 304 and a portion of each spring 310 is a particularly well suited clamp for use in the apparatus 300.

The number and orientation of the springs 310 will depend on several considerations, including the application to which the apparatus 300 is placed. In one embodiment, illustrated in FIGS. 9 and 10, the apparatus 300 includes four springs 310. Each of the springs 310 is spaced equidistant from other springs 310 of the plurality. Also in this embodiment, as best illustrated in FIG. 10, each spring 310 of the plurality is spaced orthogonally from other springs 310 of the plurality. This arrangement of the springs 310 provides an apparatus 300 with a compact and efficient design that allows the desired movement of the magnet 302, 304 towards and away from each other while substantially preventing lateral movement of the magnets 302, 304 due to repulsive forces of the opposing magnetic fields 306, 308.

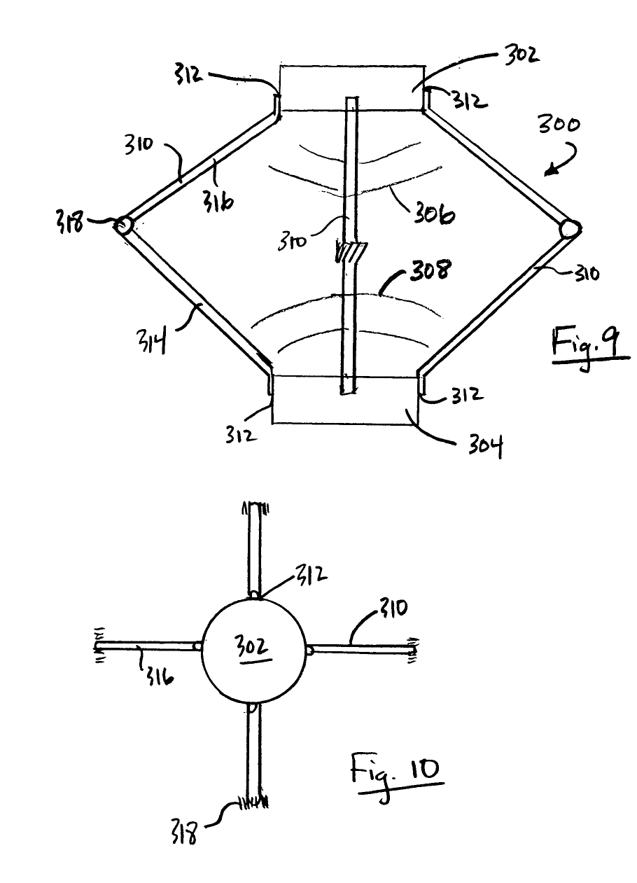

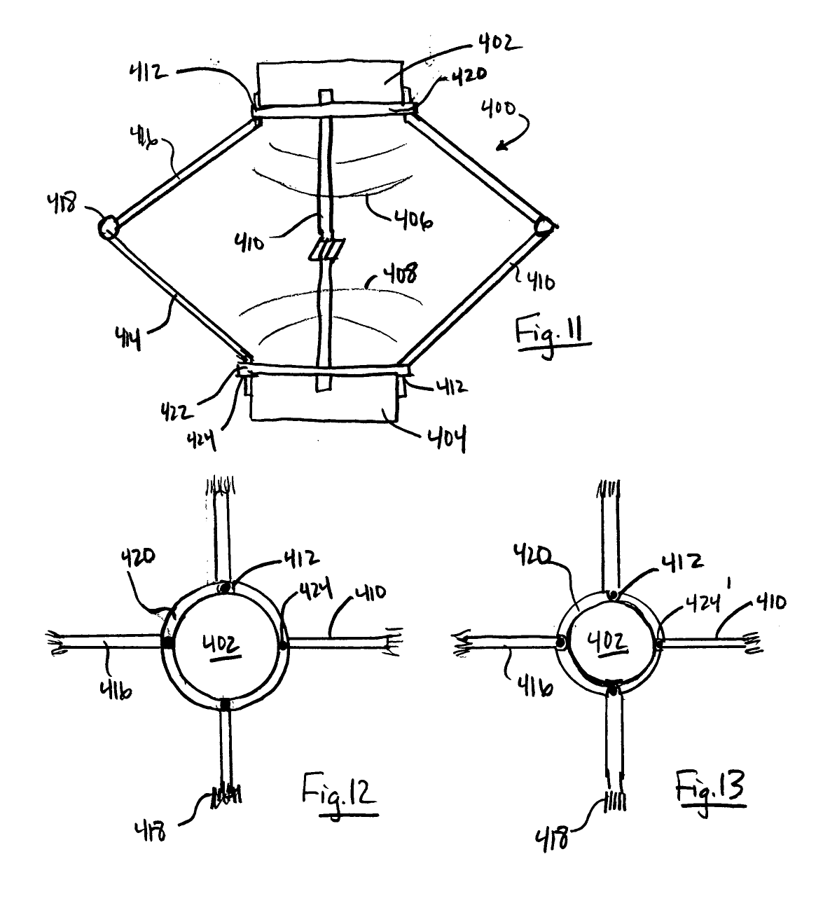

FIGS. 11 and 12 illustrate an apparatus 400 according to another embodiment of the invention. The apparatus 400 of this embodiment is similar to the embodiment described above and illustrated in FIGS. 9 and 10, except as detailed below. Accordingly, like reference numbers in FIGS. 11 and 12 refer to similar features and/or components illustrated in FIGS. 9 and 10.

In this embodiment, the apparatus 400 includes first 402 and second 404 magnets. The first magnet 402 has a first magnetic field 406 in a first orientation, and the second magnet 404 has a second magnetic field 408 in a second orientation. The second orientation opposes the first orientation. The apparatus 400 includes a plurality of springs 410. Each spring 410 includes first 414 and second 416 arm portions, and a coil portion 418 disposed between the arm portions 414, 416.

In this embodiment, the attachment points 412 are formed between the springs 410 and first 420 and second 422 base members. The base members 420, 422 provide a surface onto which the magnets 402, 404, respectively, can be disposed. Further, the base members 420, 422 provide a position at which the springs 412 can be attached to the base members 420, 422 to form the attachment points 412. The base members 420, 422 can have any suitable size, shape, configuration, and composition, and need only provide a surface onto which the magnets 402, 404 can be disposed. If desired, the base members 420, 422 can also provide for the attachment points 412 as described below. Metal base members 420, 422 are particularly well suited for use in the apparatus 400 because attractive forces between the metal and the magnets 402, 404 may enhance the stability and/or ruggedness of the apparatus 400.

As in the previous embodiment, the attachments points 412 can comprise any suitable attachment between the springs 410 and the base members 420, 422. Examples of suitable attachment points include weld joints, adhesives, and mechanical interactions between the elements. FIGS. 11 and 12 illustrate one suitable form for the attachment points 412. In this embodiment, each of the base members 420, 422 define a plurality of apertures 424. One end of each spring 410 is disposed in an aperture 424 of the first base member 420, and a another end of each spring 410 is disposed is an aperture 424 of the second base member 422. As illustrated in the figures, the respective ends of the springs 410 can pass through the thickness of the base members 420, 422. Further, the ends of the springs 410 can be crimped over the base members 420, 422 to provide additional ruggedness to the attachment points 412. Additional elements can also be used to enhance the ruggedness of the attachment points, such as weld joints and adhesives disposed in the apertures 424 of the base members 420, 422 along with the ends of the springs 410.

The apertures 424 can comprise any suitable aperture for retaining the ends of the springs 410. As illustrated in FIG. 12, the apertures 424 can comprise a hole having a closed circumference formed in the base member 420. FIG. 13 illustrates an alternative form for the aperture 424′. In this embodiment, the aperture 424′ comprises a notch formed in the base member 420. As used herein, the term “notch” refers to an aperture lacking a closed parimeter. If notches are used as the apertures 424′, it may be desirable to utilize additional elements for formation of the attachment points 412. For example, a weld joint or adhesive can be disposed at the notch 424′ to provide additional ruggedness to the attachment point 412.

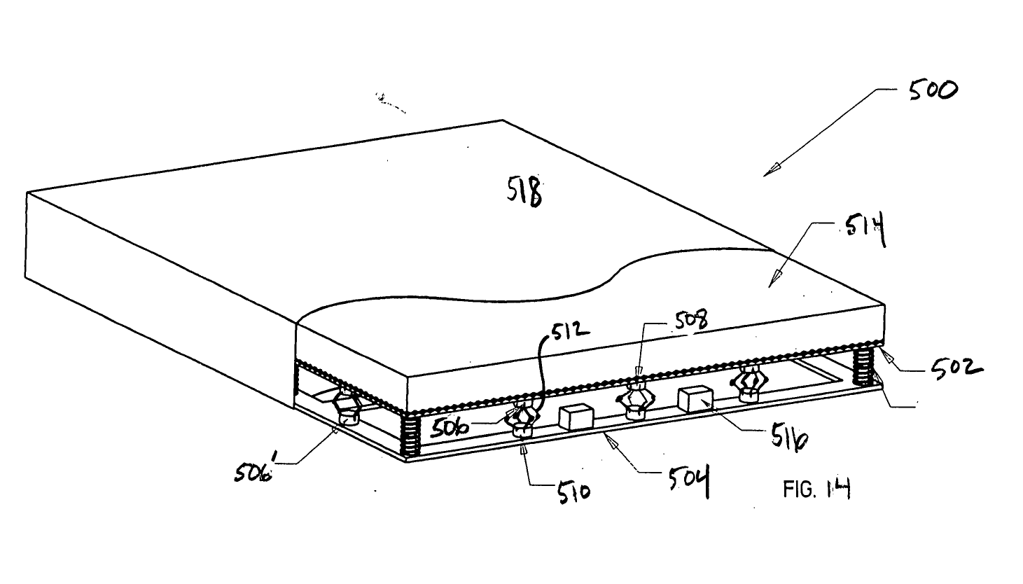

The invention also provides support apparatuses that include the apparatuses for maintaining magnets in an opposing relationship. In these embodiments, the apparatuses for maintaining magnets in an opposing relationship can be referred to as coil members. FIG. 14 illustrates a support apparatus 500 according to an embodiment of the invention. In this embodiment, the support apparatus 500 comprises first 502 and second 504 frame members. A plurality of coil members 506 are disposed between and connected to the frame members 502, 504. Each coil member 506 comprises first 508 and second 510 magnets. The first magnet 508 has a first magnetic field in a first orientation and a second magnet 510 has a second magnetic field in a second orientation that opposes the first orientation. Each of the coil members 506 further comprises a plurality of springs 512 that are attached to the first 508 and second 510 magnets. The support apparatus 500 further includes a body support surface 514 disposed on the first frame member 502.

The first 502 and second 504 frame members can be any suitable frame member as described above for other embodiments of support apparatuses of the invention. Also, the body support surface 514 can comprise any suitable body support surface as described above for other embodiments of support apparatuses of the invention.

The coil members 506 can be any apparatus for maintaining magnets in an opposing relationship in accordance with the invention. Accordingly, the attachment of the springs 512 to the magnets 508, 510 can comprise a direct attachment between the springs 512 and the magnets 508, 510, and can also comprise the use of a base member and an attachment between the springs 512 and such base member, as described above.

It may be desirable to use a first set of coil members 506 that includes a first number of springs 512 and a second set of coil numbers 506′ that include a second number of springs 512. The first number of springs 512 can be different from the second number of springs 512. The use of different numbers of springs 512 in different sets of coil members 506, 506′ may allow more efficient packaging of the support apparatus 500. For example, as illustrated in FIG. 14, coil members 506′ with fewer springs 512 may allow placement of the coil members 506′ near an edge of the frames 502, 504 without the possibility of a spring 512 protruding out of a plane perpendicular to edges of the frames 502, 504. In one embodiment, a first set of coil members 506, which includes a greater number of springs 512, is disposed on inner frame members while a second set of coil members 506′ that includes a lesser number of springs 512 is disposed on outer frame members. The inner frame members span a distance between outer frame members.

The support apparatus 500 can also include spacing members 516 as described above for other embodiments of support apparatuses according to the invention. In some embodiments, the spacing members 516 comprise foam members.

As illustrated in FIG. 14, the support apparatus 500 can also include a covering 518 that surrounds the first frame member 502, the second frame member 504, and body support surface 514. The use of covering 518 provides an enclosure for the internal components of the support apparatus 500, and may enable efficient handling and use of the support apparatus 500.

The foregoing disclosure includes the best mode devised by the inventor for practicing the invention. It is apparent, however, that several variations in the apparatuses of the present invention may be conceivable by one skilled in the art. Inasmuch as the foregoing disclosure is intended to enable one skilled in the pertinent art to practice the instant invention, it should not be construed to be limited thereby, but should be construed to include such aforementioned variations.

I claim:

1. An apparatus for maintaining magnets in an opposing relationship; comprising:
a first magnet having a first magnetic field in a first orientation;
a second magnet having a second magnetic field in a second orientation that substantially opposes the first orientation;
a plurality of springs, each spring of the plurality of springs attached to the first and second magnets.

2. The apparatus of claim 1, wherein each spring comprises first and second arm portions and a coil portion disposed between the first and second arm portions.

3. The apparatus of claim 1, wherein the plurality of springs comprises four springs.

4. The apparatus of claim 3, wherein each spring of the plurality of springs is spaced orthogonally from other springs of the plurality of springs.

5. The apparatus of claim 1, wherein each spring of the plurality of springs is spaced equidistant from other springs of the plurality of springs.

6. The apparatus of claim 1, wherein at least one of the first and second magnets comprises a rare earth magnet.

7. The apparatus of claim 1, wherein the first magnetic field has a first strength and the second magnetic field has a second strength, and wherein the first strength is greater than the second strength.

8. An apparatus for maintaining magnets in an opposing relationship; comprising:
a first magnet having a first magnetic field in a first orientation;
a first base member, the first magnet disposed on the first base member;
a second magnet having a second magnetic field in a second orientation that substantially opposes the first orientation;
a second base member, the second magnet disposed on the second base member;
a plurality of springs, each spring of the plurality of springs attached to the first and second base members.

9. The apparatus of claim 8, wherein the first base member comprises a metal member.

10. The apparatus of claim 8, wherein the first base member comprises a plurality of apertures and a portion of each spring of the plurality of springs is disposed in one of the plurality of apertures.

11. The apparatus of claim 10, wherein each aperture of the plurality of apertures comprises a hole or a notch.

12. The apparatus of claim 8, wherein at least one of the first and second magnets comprises a rare earth magnet.

13. A support apparatus for supporting at least a portion of a body of an individual, said support apparatus comprising:
a first frame member;
a second frame member;
a plurality of coil members, each coil member attached to the first and second frame members and comprising a first magnet having a first magnetic field in a first orientation, a second magnet having a second magnetic field in a second orientation, and a plurality of springs, each spring of the plurality of springs attached to the first and second magnets; and
a body support surface disposed on the first frame member.

14. The apparatus of claim 13, wherein a first set of the plurality of coil members comprises a first number of springs, a second set of the plurality of coil members comprises a second number of springs, and the first number is greater than the second number.

15. The apparatus of claim 13, wherein each spring comprises first and second arm portions and a coil portion disposed between the first and second arm portions.

16. The apparatus of claim 13, wherein at least one of the first and second magnets comprises a rare earth magnet.

17. The apparatus of claim 13, further comprising at least one spacing member disposed between the first and second frame members.

18. The apparatus of claim 17, wherein the at least one spacing member comprises a foam member.

19. The apparatus of claim 13, further comprising a covering surrounding the first frame member, the second frame member, and the body support surface.

20. The apparatus of claim 13, wherein the body support surface comprises a cushion member.
